(19) United States
(12) Patent Application Publication
(10) Pub. No.: US 2026/0142420 A1
(43) Pub. Date: May 21, 2026

(54) CONNECTOR

(71) Applicant: SUMITOMO WIRING SYSTEMS, LTD., Mie (JP)

(72) Inventor: Shifumi SADAKATA, Mie (JP)

(21) Appl. No.: 19/377,754

(22) Filed: Nov. 3, 2025

(30) Foreign Application Priority Data
Nov. 15, 2024 (JP) 2024-199804

(51) Int. Cl. H01R 13/641; H01R 13/52

(52) U.S. Cl. CPC H01R 13/641; H01R 13/5219

(57) ABSTRACT

A connector includes a first connector and a second connector that can be mated with each other. The first connector includes a contraction part that contracts by coming into contact with the second connector during mating. The second connector includes a confirmation part for checking the position thereof relative to the contraction part.

### CROSS-REFERENCE TO RELATED APPLICATIONS

This application is based on and claims priority from Japanese Patent Application No. 2024-199804, filed on November 15, 2024, with the Japan Patent Office, the disclosure of which is incorporated herein in its entirety by reference.

### TECHNICAL FIELD

The present disclosure relates to a connector.

### BACKGROUND

JP 2017-123288 A discloses a grommet-included connector in which a grommet is attached to the rear of the connector. The connector is inserted into an attachment hole in a panel and attached to the panel. The grommet has a panel contact portion that comes into close contact with the edge of the attachment hole. The connector attached to the panel is mated with a mating connector.

JP 2019-160476 A discloses a female connector and a male connector that are capable of mating with each other. The female connector has a rubber boot that is attached to a housing so as to cover the outer peripheral surface of the housing.

### SUMMARY

JP 2017-123288 A does not describe a mating detection means for detecting whether the connector and the mating connector are properly mated. Similarly, JP 2019-160476 A does not describe a mating detection means for detecting whether the female connector and the male connector are properly mated.

For example, in the case of a non-waterproof connector, it is possible to detect whether the connector and the mating connector are properly mated by visually confirming the locking state of a lock arm provided on the connector to the mating connector. However, in a waterproof connector whose outer surface is covered with a rubber member such as a grommet or a rubber boot, the lock arm is hidden by the rubber member and cannot be seen, thus making it difficult to detect the mating state.

In view of this, an object of the present disclosure is to provide a connector that enables detecting the mating state without relying on a lock arm or the like.

A connector of the present disclosure includes a first connector and a second connector configured to be mated with each other, wherein the first connector is provided with a contraction part configured to contract by coming into contact with the second connector during mating, and the second connector is provided with a confirmation part configured to enable checking a position of the confirmation part relative to the contraction part.

According to the present disclosure, it is possible to provide a connector that enables detecting the mating state without relying on a lock arm or the like.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view of a connector according to a first embodiment, showing a state in which a first connector and a second connector are mated with each other.

FIG. 2 is a cross-sectional view of the connector according to the first embodiment, showing a state in which the first connector and the second connector are partially mated with each other.

FIG. 3 is a front perspective view of the second connector in the connector according to the first embodiment.

FIG. 4 is a front view of a housing of the first connector in the connector according to the first embodiment.

FIG. 5 is a rear view of the housing of the first connector in the connector according to the first embodiment.

FIG. 6 is a rear perspective view of the housing of the first connector in the connector according to the first embodiment.

FIG. 7 is a front view of a rubber member in the connector according to the first embodiment.

FIG. 8 is a front view of the first connector in the connector according to the first embodiment.

FIG. 9 is a rear view of the first connector in the connector according to the first embodiment.

FIG. 10 is a front perspective view of the first connector in the connector according to the first embodiment.

FIG. 11 is a perspective view of the connector according to the first embodiment as viewed from the first connector side, showing a state in which the first connector and the second connector are mated with each other.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

1. A connector of the present disclosure includes a first connector and a second connector configured to be mated with each other, wherein the first connector is provided with a contraction part configured to contract by coming into contact with the second connector during mating, and the second connector is provided with a confirmation part configured to enable checking a position of the confirmation part relative to the contraction part.

After mating of the first connector and the second connector, by confirming the relative positions of the contraction part and the confirmation part, it is possible to detect whether the first connector and the second connector are mated correctly. For example, if the contraction part is contracted and the contraction part is not visible from the confirmation part, or the visible area of the contraction part is reduced by a predetermined amount, it can be detected that the first connector and the second connector are mated correctly. On the other hand, if the contraction part is not sufficiently contracted and the contraction part is visible from the confirmation part, or the visible area of the contraction part has not been reduced by a predetermined amount, it can be detected that the first connector and the second connector are not mated correctly and are in a partially-mated state.

2. In the connector described in (1), it is preferable that the contraction part has a bellows shape with a pair of a peak and a valley repeated in a mating direction.

According to the configuration described in (2), the amount of contraction of the contraction part in contact with the second connector side can be made large, so that the reliability of detecting the mating state of the first connector and the second connector is excellent.

3. In the connector described in (1) or (2), it is preferable that the contraction part is elastically deformable in the mating direction.

According to the configuration described in (3), when the contraction part comes into contact with the second connector, the first connector and the second connector can be separated from each other by the repulsive force of the contraction part. For example, when the worker finishes the mating operation, the first connector and the second connector are separated from each other, and therefore it can be detected that the first connector and the second connector are not locked to each other and are in a partially-mated state.

4. In the connector according to (3), it is preferable that the contraction part has a perfect circular ring shape as viewed from a second connector side.

According to the configuration described in (4), when the contraction part comes into contact with the second connector side, the force of separating the first connector and the second connector from each other can be efficiently transmitted to the worker.

5. In the connector described in (3) or (4), it is preferable that the contraction part is provided on a rubber member that covers an outer peripheral surface of a housing of the first connector.

According to the configuration described in (5), the rubber member can have both a function of enabling detecting the mating state of the first connector and the second connector and a function of waterproofing the first connector.

6. In the connector described in (5), it is preferable that the housing has a lock arm configured to lock to the second connector, and the rubber member is shaped to entirely cover the outer peripheral surface of the housing and has a mark at a position corresponding to the lock arm.

According to the configuration described in (6), the entire outer peripheral surface of the housing is covered with the rubber member, and the mark is provided at a position corresponding to the lock arm, so that the mating posture of the first connector can be corrected using the mark as a guide, and the lock arm can be brought to a position where it can lock to the second connector. In particular, in the present disclosure, when detecting the mating state of the first connector and the second connector, it is only necessary to check the relative positions of the confirmation part and the contraction part, so there is no need to check the locking state of the lock arm to the second connector by pulling back the rubber member, for example.

7. In the connector described in (5) or (6), it is preferable that the contraction part is in liquid-tight contact with the second connector while contracted in a mated state.

According to the configuration described in (7), the contraction part can have both a function of waterproofing the second connector side in the mated state and a function of enabling detecting the mating state of the first connector and the second connector.

8. In the connector described in (1) or (7), it is preferable that the second connector has a wall surface that widens in a direction intersecting the mating direction and faces a side where the first connector is located, the confirmation part has a tubular shape protruding from the wall surface, and the contraction part is arranged inside the confirmation part in contact with the wall surface in the mated state.

According to the configuration described in (8), the mating state of the first connector and the second connector can be detected by checking the state of the contraction part arranged inside the confirmation part during mating.

9. In the connector described in (8), it is preferable that a length of the confirmation part in the mating direction is set to be shorter than a length of the contraction part in the mating direction in a natural state of the contraction part in which no external force is received, and is set to be longer than or equal to the length of the contraction part in the mating direction in a contracted state of the contraction part in contact with the wall surface in the mated state.

According to the configuration described in (9), by confirming that the contraction part is entirely arranged inside the confirmation part, it is possible to detect that the first connector and the second connector are correctly mated. In contrast, by confirming that a portion of the contraction part protrudes from inside of the confirmation part, it is possible to detect that the first connector and the second connector are not correctly mated. Thus, it is possible to easily detect the mating state of the first connector and the second connector.

### Details of Embodiments of Present Disclosure

Specific examples of a connector of the present disclosure will be described below with reference to the drawings. It should be noted that the present invention is not limited to the examples herein, but rather is indicated by the scope of claims, and is intended to include all modifications within a meaning and scope equivalent to the scope of claims.

### First Embodiment

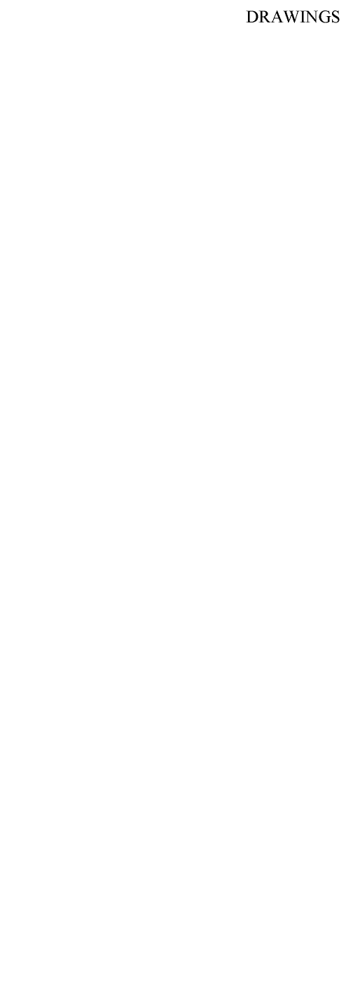

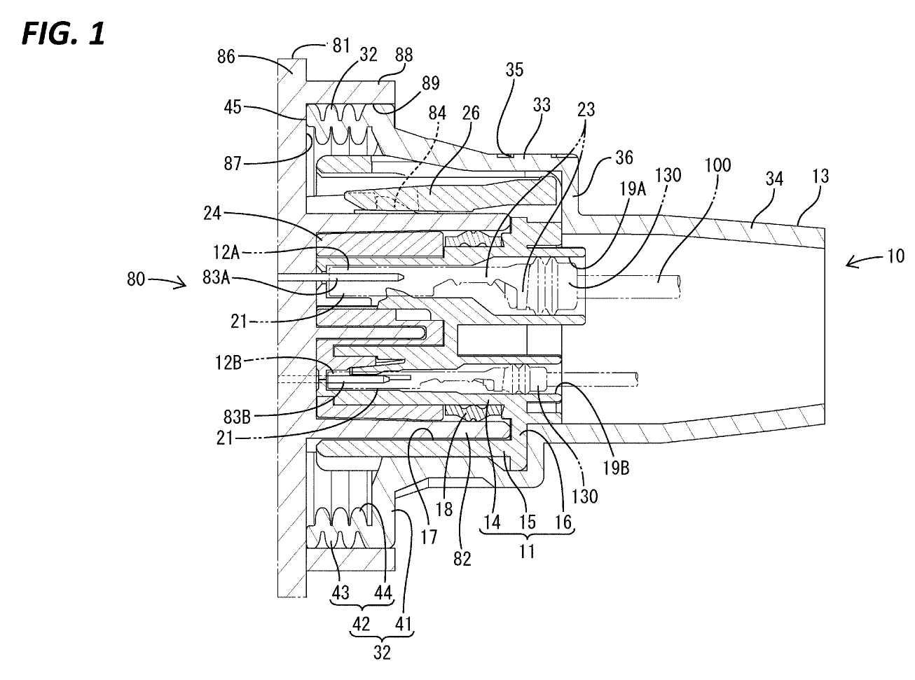

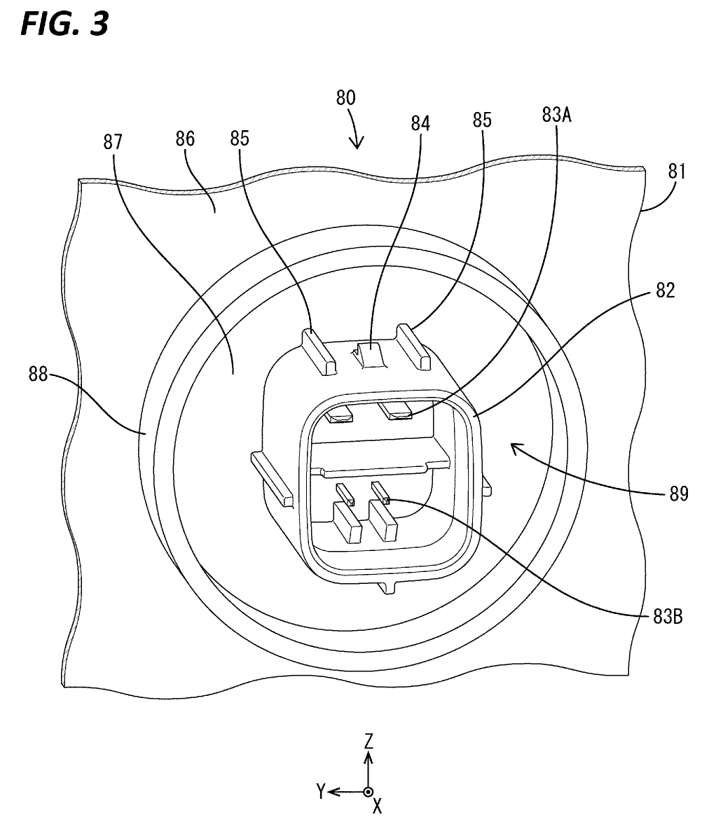

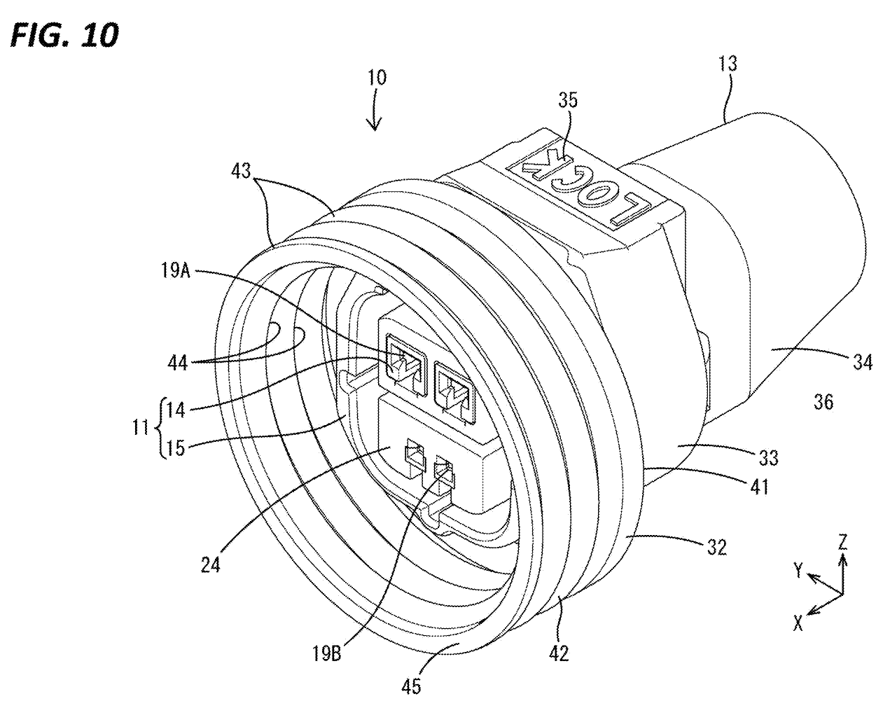

As shown in FIG. 1, a connector according to a first embodiment includes a first connector 10 and a second connector 80 that can be mated together. The second connector 80 is provided integrally with a device 81. In the following description, the second connector 80 integrated with the device 81 will be referred to as the second connector 80 side. For convenience, the direction in which the first connector 10 and the second connector 80 are mated together will be defined as the forward direction, and the up-down direction in the drawings will be defined as the up-down direction. In FIGS. 3 and 10, symbols X, Y, and Z represent forward, leftward, and upward directions, respectively.

### Second Connector 80 Side

As shown in FIG. 3, the second connector 80 has a hood part 82 made of synthetic resin and second terminal fittings 83A and 83B made of conductive metal. The hood part 82 is shaped as a rectangular tube with rounded corners and is open forward. The hood part 82 has a lock protrusion 84 that protrudes from the upper wall thereof. The lock protrusion 84 is claw-shaped and can be locked with a lock arm 26 of the first connector 10 described later. The hood part 82 also has a pair of protection walls 85 protruding from the upper wall thereof on the left and right sides of the lock protrusion 84. The protection walls 85 are shaped as ribs extending parallel to each other in the front-rear direction. The protection walls 85 are arranged so as to cover the locked region of the lock arm 26 and the lock protrusion 84 from the left and right sides in the mated state.

The second terminal fittings 83A and 83B are male terminal fittings and pass through the rear wall of the hood part 82 in the front-rear direction. The second terminal fittings 83A and 83B protrude into the hood part 82 and are connected to first terminal fittings 12A and 12B (described later) of the first connector 10. In the first embodiment, the second terminal fittings 83A and 83B are configured as a large tab-shaped second terminal fitting 83A and a small pin-shaped second terminal fitting 83B.

The device 81 is made of synthetic resin and has a wall part 86 that extends in a direction intersecting the front-rear direction. The rear wall of the hood part 82 is included in the wall part 86. The wall part 86 has a wall surface 87 that faces forward. The wall surface 87 extends along the radial direction of the hood part 82.

The wall part 86 has a tubular confirmation part 88 protruding from the wall surface 87 thereof. The confirmation part 88 has a perfect circular ring shape as viewed from the front. The inner peripheral surface of the confirmation part 88 faces the outer peripheral surface of the rear end portion of the hood part 82 with a gap therebetween in the radial direction. An insertion space 89, into which a contraction part 32 (described later) of the first connector 10 can be inserted, is formed between the inner peripheral surface of the confirmation part 88 and the outer peripheral surface of the rear end portion of the hood part 82. As shown in FIG. 1, a portion of the wall surface 87 of the wall part 86 that faces the insertion space 89 is in contact with the leading end surface (contact surface 45) of the contraction part 32.

### First Connector 10

As shown in FIG. 1, the first connector 10 has a housing 11 made of synthetic resin, the first terminal fittings 12A and 12B made of conductive metal, and a rubber member 13 made of rubber such as silicone rubber. The housing 11 has a block-shaped housing body 14 and a tubular mating tube part 15 that covers the outer peripheral surface of the housing body 14. The first connector 10 also has a coupling part 16 at its rear end that connects the housing body 14 and the mating tube part 15 along the radial direction. The space between the housing body 14 and the mating tube part 15 and in front of the coupling part 16 is a mating space 17 into which the hood part 82 of the second connector 80 can be mated. A rubber seal ring 18 is attached to the outer peripheral surface of the housing body 14. The seal ring 18 is elastically compressed between the housing body 14 and the hood part 82 to maintain a liquid-tight seal between the housing body 14 and the hood part 82.

As shown in FIG. 1, the housing body 14 has cavities 19A and cavities 19B extending in the front-rear direction. The first terminal fittings 12A and 12B are respectively inserted into the cavities 19A and 19B from the rear side and held therein. The first terminal fittings 12A and 12B have box parts 21 that receive the front portions of the second terminal fittings 83A and 83B. Elastic contact portions (not shown) are provided inside the box parts 21. When the second terminal fittings 83A and 83B come into contact with the elastic contact portions inside the box parts 21, the first terminal fittings 12A and 12B and the second terminal fittings 83A and 83B are electrically connected. The first terminal fittings 12A and 12B have barrel parts 23 behind the box parts 21. The barrel parts 23 are crimped and connected to the end portions of electric wires 100. The barrel parts 23 are also crimped and fixed to rubber plugs 130 that are fitted to the outer peripheral surfaces of the electric wires 100. The rubber plugs 130 are inserted into the rear ends of the cavities 19A and 19B to maintain a liquid-tight seal between the inner peripheral surfaces of the cavities 19A and 19B and the outer peripheral surfaces of the electric wires 100.

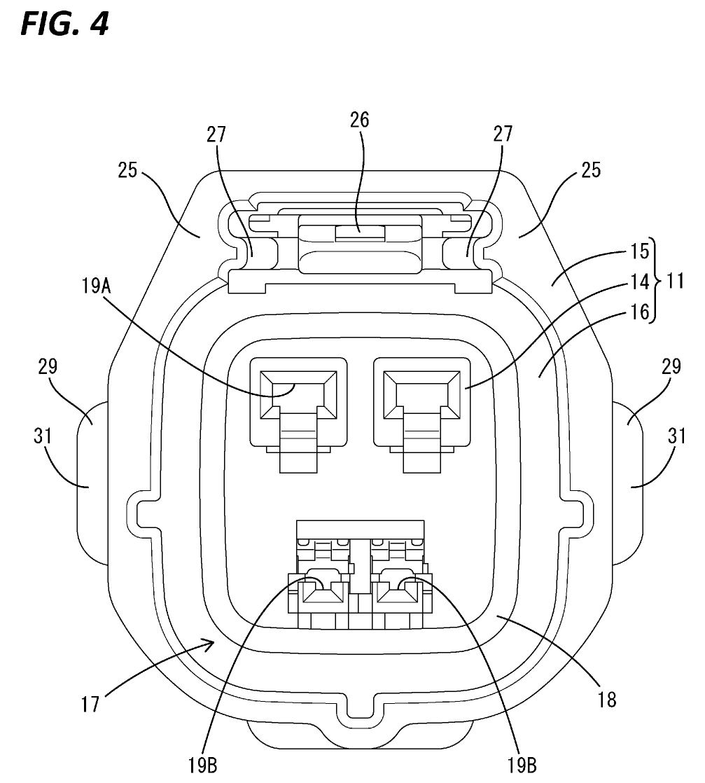

In the first embodiment, as shown in FIG. 4, out of the upper and lower cavities 19A and 19B, the upper cavities 19A are formed to have a larger opening width in the horizontal direction than the lower cavities 19B. As shown in FIG. 1, the upper cavities 19A receive and store the larger first terminal fittings 12A that are connectable to the second terminal fittings 83A. The lower cavities 19B receive and store the smaller first terminal fittings 12B that are connectable to the second terminal fittings 83B.

A front member 24 is attached to the front of the housing body 14. As shown in FIG. 10, the front member 24 is arranged so as to cover the front surface of the housing body 14 except for the areas around the openings of the cavities 19A and 19B, and to cover the outer peripheral surface of the front part of the housing body 14. The front member 24 also has the function of suppressing the case where the seal ring 18 deviates forward.

As shown in FIGS. 4 to 6, a pair of left and right side wall parts 25 are provided on the upper wall of the mating tube part 15, and the lock arm 26 is provided between the side wall parts 25 that face each other in the horizontal direction. The lock arm 26 has a pair of left and right fulcrum parts 27 connected to the side wall parts 25, at the left and right ends of the rear end part. The lock arm 26 is elastically deformable in the vertical direction in a seesaw manner with the fulcrum parts 27 serving as fulcrums. As shown in FIG. 1, the lock arm 26 is arranged so as to be capable of locking to the lock protrusion 84 when the first connector 10 and the second connector 80 are mated together. The protection walls 85 of the second connector 80 are arranged between the lock arm 26 and the side wall parts 25 in the mated state.

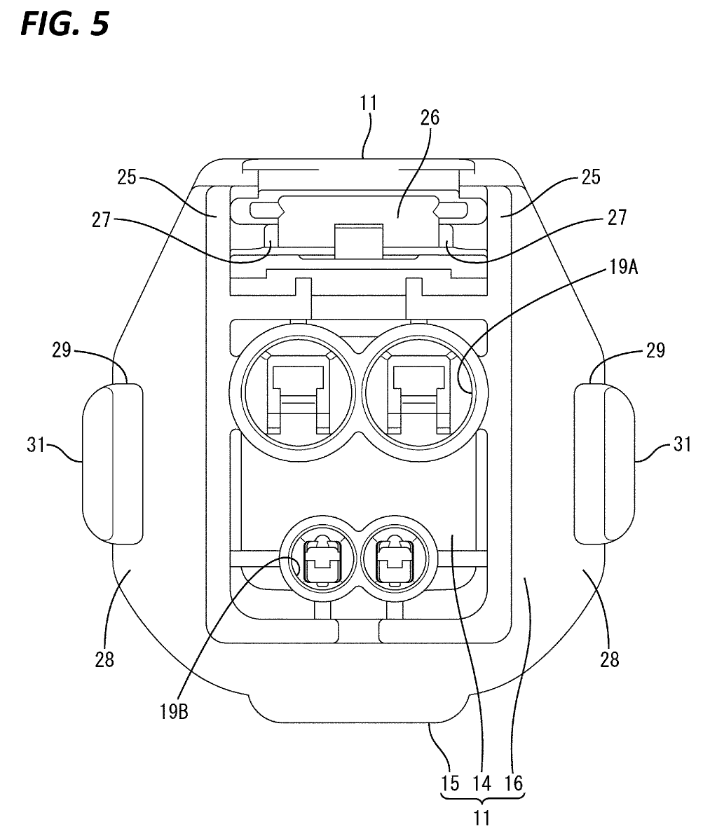

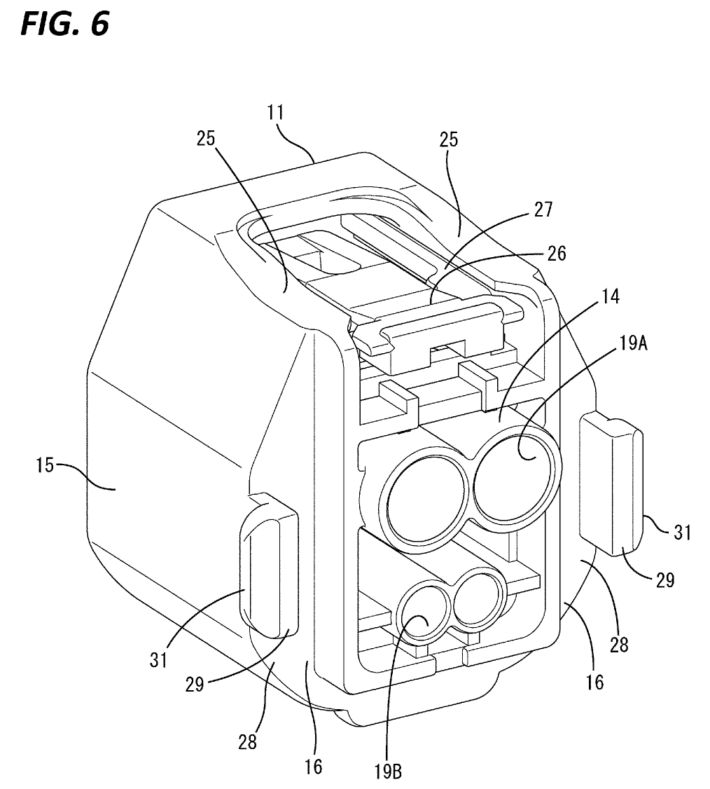

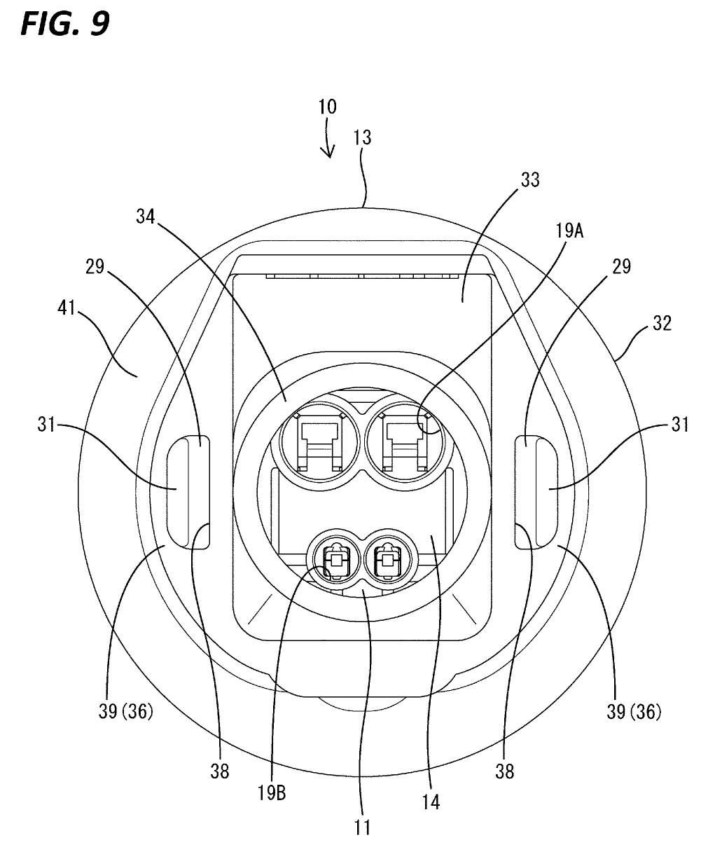

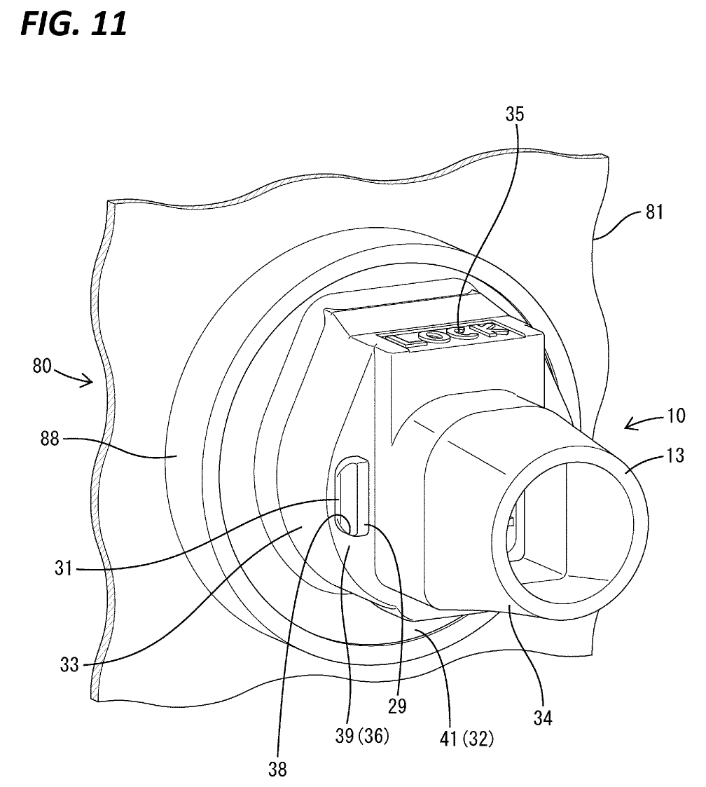

As shown in FIGS. 5 and 6, the left and right rear surfaces of the mating tube part 15 form end faces 28 that extend in the vertical direction and are continuous with the coupling part 16. The housing 11 has a pair of holding parts 29 that protrude rearward from the left and right end faces 28. Each holding part 29 is shaped like a protruding piece that is elongated in the vertical direction. The holding parts 29 have holding protrusions 31 formed at the rear end and protruding outward to the left and right. As shown in FIGS. 9 and 11, the holding parts 29 are inserted into holding holes 38 (described later) of the rubber member 13. The holding protrusions 31 are arranged so as to be capable of locking to opening edge portions (hook surfaces 39) of the holding holes 38 formed in the rear surface of the rubber member 13.

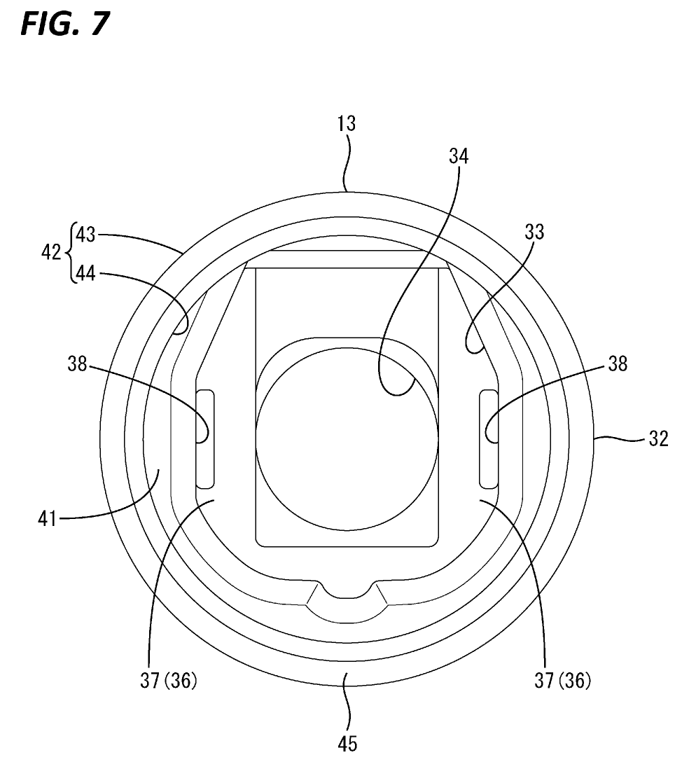

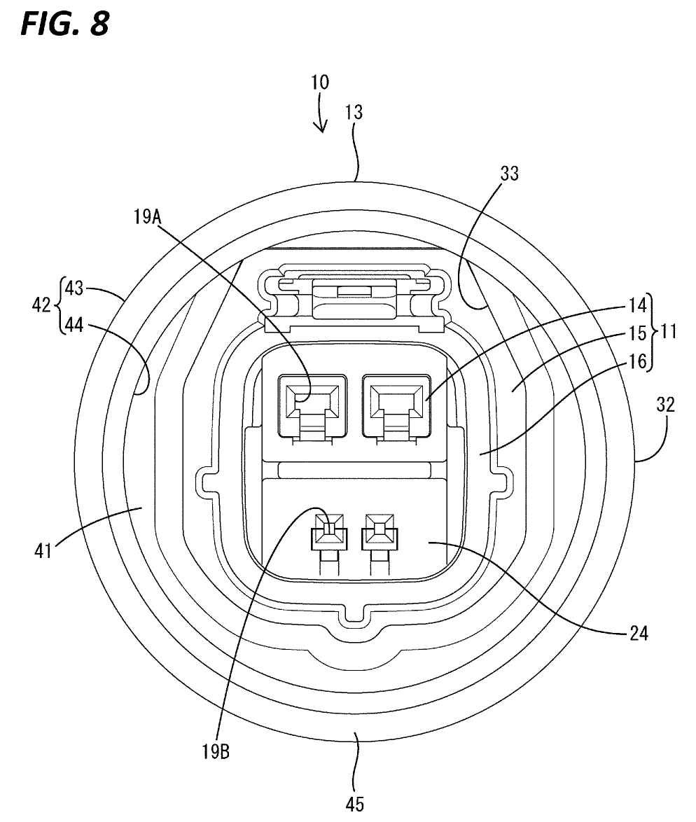

FIG. 10 illustrates an example in which the rubber member 13 is as a tubular rubber boot with an axis extending in the front-rear direction. The rubber member 13 is configured such that the contraction part 32, a body part 33, and a lead-out part 34 are connected to each other from the front side to the rear side. As shown in FIGS. 7 and 8, the inner peripheral surface of the body part 33 has a cross-sectional shape corresponding to the outer peripheral surface of the mating tube part 15 of the housing 11, and comes into close contact with the outer peripheral surface of the mating tube part 15. As shown in FIGS. 10 and 11, the lead-out part 34 has a cylindrical shape and is formed so as to be longer than the body part 33 in the front-rear direction. The electric wires 100 connected to the first terminal fittings 12A and 12B are inserted into the lead-out part 34 and drawn out rearward.

As shown in FIGS. 1 and 10, the body part 33 has a mark 35 for determining whether the lock arm 26 is positioned therein. The mark 35 is formed by engraving letters or symbols at a position on the body part 33 corresponding to the lock arm 26, for example. In the first embodiment, the mark 35 is formed by letters such as "LOCK" on the flat upper wall surface of the body part 33.

As shown in FIG. 11, the body part 33 has a step 36 at its rear end that widens radially from the front end of the lead-out part 34. As shown in FIG. 7, a portion of the inner peripheral surface of the body part 33 that corresponds to the step 36 is configured as an abutment surface 37 that extends along the radial direction (vertical and horizontal directions). The abutment surface 37 of the body part 33 comes into contact with the end faces 28 of the housing 11 from behind, and suppresses the case where the rubber member 13 comes out rearward from the housing 11.

The pair of holding holes 38 are formed so as to pass through the left and right ends of the step 36. The front ends of the holding holes 38 are open at the abutment surface 37. The rear ends of the holding holes 38 are open at the rear end face of the step 36. As shown in FIG. 9, the rear end face of the step 36 constitutes the hook surfaces 39 that extend along the vertical direction. The holding holes 38 have an opening shape that is elongated in the vertical direction. The outer peripheral surfaces of the holding parts 29 come into close contact with the inner peripheral surfaces of the holding holes 38. The holding protrusions 31 of the holding parts 29 are hooked in contact with the opening edges of the holding holes 38 on the hook surfaces 39, thereby suppressing the case where the rubber member 13 comes out forward from the housing 11.

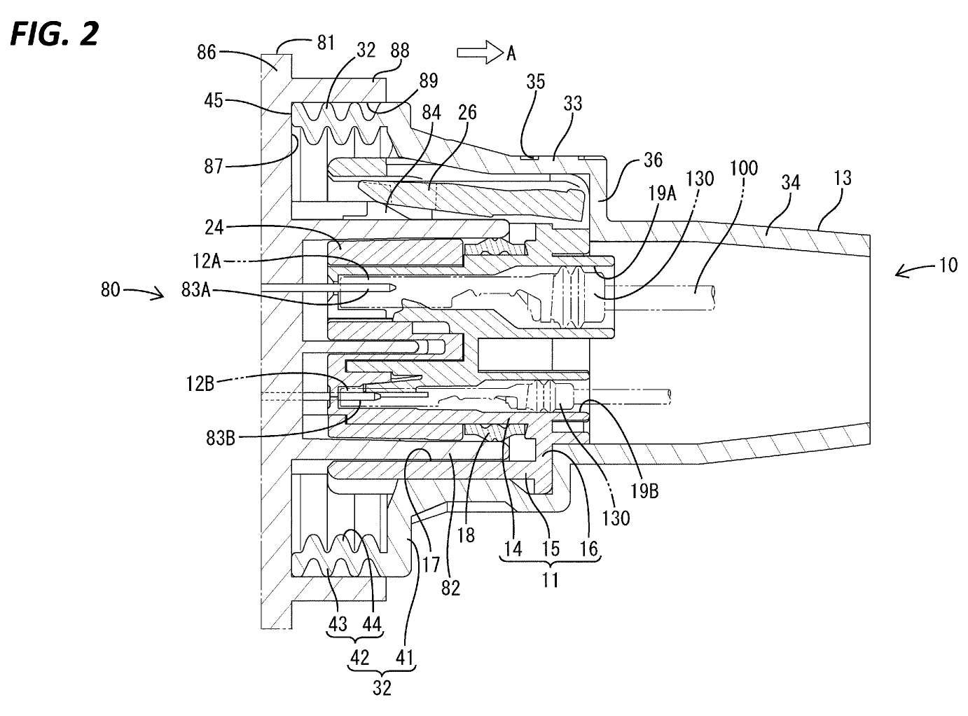

As shown in FIG. 10, the contraction part 32 has a cylindrical shape that is slightly larger than the body part 33 as a whole. As shown in FIGS. 1 and 2, the contraction part 32 has a flange portion 41 that protrudes radially from the front end of the body part 33, and a bellows portion 42 that protrudes forward from the radially outer end of the flange portion 41. When the first connector 10 and the second connector 80 are mated, the bellows portion 42 is arranged in the insertion space 89 and stored inside the confirmation part 88. The bellows portion 42 has a bellows shape in which a pair of a peak 43 protruding radially outward and a valley 44 recessed radially inward is repeated at least twice in the front-rear direction. In the first embodiment, the peaks 43 and the valleys 44 extend concentrically with the axis of the rubber member 13. The peaks 43 have the same shape at a fixed distance from the axis of the rubber member 13. Similarly, the valleys 44 also have the same shape at a fixed distance from the axis of the rubber member 13. The peaks 43 and the valleys 44 have diameter dimensions (inner diameter and outer diameter) that fall within the radial range of the insertion space 89 on the second connector 80 side.

As shown in FIGS. 1 and 2, the bellows portion 42 has a side cross section that has a continuous wave shape due to the peaks 43 and the valleys 44. As shown in FIG. 7, the front end (leading end) of the bellows portion 42 is configured as a contact surface 45 that is annular as viewed from the front, specifically a perfect circular ring shape. The contact surface 45 of the bellows portion 42 extends along the radial direction and is pressed against the wall surface 87 of the wall part 86 when the first connector 10 and the second connector 80 are mated. The contact surface 45 of the bellows portion 42 and the radially outer end of the flange portion 41 are arranged at the same position in the radial direction. The front-rear length of the confirmation part 88 is shorter than the front-rear length (length in the mating direction) of the contraction part 32 in a natural state of not contracting due to an external force, and is longer than or equal to the front-rear length of the contraction part 32 in a contracted state (fully contracted state) in which the contact surface 45 is pressed against the wall surface 87 of the wall part 86 when the first connector 10 and the second connector 80 are mated.

### Action of Connectors

During assembly, the rubber member 13 is attached to the housing 11 of the first connector 10, the drawn-out portions of the electric wires 100 extending from the housing 11 are arranged inside the lead-out part 34, and the body part 33 comes into close contact with the outer peripheral surface of the mating tube part 15. The holding parts 29 are inserted from the front into the holding holes 38 of the rubber member 13. As shown in FIG. 9, the holding protrusions 31 of the holding parts 29 protrude rearward from the holding holes 38 and are hooked onto the hook surfaces 39 of the step 36. Accordingly, the rubber member 13 is held so as to not easily come out of the housing 11. As shown in FIG. 10, when the rubber member 13 is attached to the housing 11, the contraction part 32 is arranged so as to protrude forward beyond the housing 11.

Next, the first connector 10 is mated to the second connector 80. At the start of mating of the first connector 10 and the second connector 80, the position of the lock arm 26 can be determined using the mark 35 as a guide, so that the mating posture of the first connector 10 can be corrected such that the lock arm 26 reaches a position where it can be locked to the lock protrusion 84 even if it is covered with the rubber member 13 and cannot be seen from the outside.

As shown in FIG. 2, in the process of mating the first connector 10 and the second connector 80, the hood part 82 of the second connector 80 is inserted into the mating space 17 of the first connector 10, and the lock arm 26 rides up onto the lock protrusion 84 and becomes elastically deformed. The contraction part 32 is inserted into the inside (insertion space 89) of the confirmation part 88, and the contact surface 45 is pressed against the wall surface 87 of the wall part 86. Accordingly, the contraction part 32 becomes elastically contracted in the front-rear direction while the pitch between the peaks 43 and the valleys 44 decreases. The contraction part 32 and the housing 11 are arranged so as to partially overlap each other in the front-rear direction. At this stage, if the worker completes the mating operation of the first connector 10 and the second connector 80, the contraction part 32 attempts to return to the natural state due to the biasing force (repulsive force, elastic reaction force) stored by the contraction, and the first connector 10 will be pushed back from the second connector 80 and attempt to separate in the direction of arrow A in FIG. 2. By visually confirming the separated state or feeling the separating force, the worker can detect that the first connector 10 and the second connector 80 are in a partially-mated state in which the mating state has not yet been reached.

As shown in FIG. 2, when the first connector 10 and the second connector 80 are in the partially-mated state, the amount of contraction of the contraction part 32 is smaller than the amount of contraction when fully contracted in the mated state. Therefore, the rear end of the contraction part 32 is arranged so as to protrude (be exposed) rearward from the rear end of the confirmation part 88. Therefore, also by confirming or feeling the state in which the rear end of the contraction part 32 protrudes from the confirmation part 88, the worker can detect that the first connector 10 and the second connector 80 are in the partially-mated state.

As shown in FIG. 1, when the first connector 10 is correctly mated to the second connector 80, the lock arm 26 elastically returns to its original position and is positioned so as to be able to be locked to the lock protrusion 84. This maintains the first connector 10 and the second connector 80 in the mated state. The contraction part 32 is contracted in the front-rear direction by an amount of contraction greater than that in the partially-mated state, and is entirely stored inside the confirmation part 88. That is, the contraction part 32 is hidden by the confirmation part 88 and cannot be seen. Even if the locking state between the lock arm 26 and the lock protrusion 84 is not visible due to the rubber member 13, the worker can detect that the first connector 10 and the second connector 80 are correctly mated by confirming the position of the contraction part 32 relative to the confirmation part 88. Since the contraction part 32 is arranged in the fully contracted state inside the confirmation part 88 in the mated state, the first connector 10 and the second connector 80 are biased in the direction of separation, thereby eliminating a clearance that might be formed between the lock arm 26 and the lock protrusion 84. As a result, it is possible to suppress rattling between the first connector 10 and the second connector 80 in the mating state.

As described above, the connector according to the first embodiment includes the first connector 10 and the second connector 80 that can be mated with each other. The first connector 10 includes the contraction part 32 that contracts by coming into contact with the second connector 80 during mating. The second connector 80 includes the confirmation part 88 for checking the position relative to the contraction part 32. According to the configuration of the present disclosure, after the mating operation of the first connector 10 and the second connector 80, it is possible to detect whether the first connector 10 and the second connector 80 are properly mated by checking the relative positions of the contraction part 32 and the confirmation part 88.

Since the contraction part 32 has a bellows shape with the peaks 43 and valleys 44 repeated in the front-rear direction (mating direction), it is possible to ensure a large amount of contraction of the contraction part 32 when in contact with the second connector 80, resulting in excellent reliability in detecting the mating state of the first connector 10 and the second connector 80.

Since the contraction part 32 is elastically deformable in the front-rear direction, when the first connector 10 and the second connector 80 are in the partially-engaged state, the repulsive force of the contraction part 32 can move the first connector 10 and the second connector 80 away from each other, thereby improving the reliability of detecting the partially-engaged state.

Since the contraction part 32 has a perfect circular ring shape as viewed from the front side (the second connector 80 side), the force of moving the first connector 10 and the second connector 80 away from each other can be efficiently transferred to the worker.

Since the contraction part 32 is provided on the rubber member 13 covering the outer peripheral surface of the housing 11 of the first connector 10, the rubber member 13 can be provided with both a function of enabling detecting the mating state of the first connector 10 and the second connector 80 and a function of waterproofing the first connector 10.

The rubber member 13 covers the entire outer peripheral surface of the housing 11 and has the mark 35 at a position corresponding to the lock arm 26, and therefore the mating posture of the first connector 10 can be corrected using the mark 35 as a guide, and the lock arm 26 can be brought into a position where it can lock the second connector 80. In particular, in the present disclosure, in order to detect the mating state of the first connector 10 and the second connector 80, it is only necessary to confirm the relative positions of the confirmation part 88 and the contraction part 32, so that there is no need to confirm the locking state of the lock arm 26 by shifting the rubber member 13, for example.

Since the contact surface 45 of the contraction part 32 is in liquid-tight contact with the wall surface 87 of the wall part 86 on the second connector 80 side in the mated state, the contraction part 32 can be provided with both a function of waterproofing the second connector 80 side in the mated state and a function of enabling detecting the mating state of the first connector 10 and the second connector 80.

In the first embodiment, the second connector 80 side has the wall surface 87 that widens in the direction intersecting the front-rear direction and faces the side where the first connector 10 is located, the confirmation part 88 has a tubular shape and protrudes from the wall surface 87, and the contraction part 32 is arranged inside the confirmation part 88 in contact with the wall surface 87 in the mated state. Accordingly, the mating state of the first connector 10 and the second connector 80 can be detected by checking the state of the contraction part 32 arranged inside the confirmation part 88 during mating.

Furthermore, in the first embodiment, the front-rear length (length in the mating direction) of the confirmation part 88 is set so as to be shorter than the front-rear length of the contraction part 32 in the natural state where no external force is applied, and is set so as to be longer than or equal to the front-rear length of the contraction part 32 in the fully contracted state in which the contraction part 32 is in contact with the wall surface 87 in the mated state. Accordingly, by confirming that the contraction part 32 is entirely arranged inside the confirmation part 88, it is possible to detect that the first connector 10 and the second connector 80 are properly mated. In contrast, by confirming that a portion of the contraction part 32 protrudes from the inside of the confirmation part 88, it is possible to detect that the first connector 10 and the second connector 80 are not properly mated. Therefore, the mating state of the first connector 10 and the second connector 80 can be easily detected.

### Other Embodiments of Present Disclosure

The first embodiment disclosed herein should be considered as illustrative in all respects and not restrictive.

In the first embodiment, the contraction part is provided on the rubber member, and the first connector is configured as a waterproof connector. In contrast, according to another embodiment, a contraction part may not be provided on a rubber member, and the first connector may be a non-waterproof connector.

In the first embodiment, the contraction part is provided on the rubber member so as to be elastically deformable. In contrast, according to another embodiment, the contraction part may not be provided on a rubber member, and may be shaped so as not to elastically contract.

In the first embodiment, the contraction part is configured in a bellows shape with a pair of a peak and a valley repeated at least twice in the front-rear direction. In contrast, according to another embodiment, the contraction part may be configured in a non-bellows shape constituted of one pair of a peak and a valley.

In the first embodiment, the contraction part is entirely arranged inside the confirmation part in the mated state, and the contraction part partially protrudes from the confirmation part in the partially-mated state. In contrast, according to another embodiment, the contraction part may partially protrude from the confirmation part even in the mated state. In short, it is only necessary that it is possible to check, using the confirmation part, the difference in the degree of contraction of the contraction part between the mated state and the partially-mated state.

In the first embodiment, the contraction part is in contact with the wall surface of the wall part of the device in the mated state. In contrast, according to another embodiment, in the case where the second connector is attached to a panel, the contraction part may be in contact with the wall surface of the panel in the mated state.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a first connector and a second connector configured to be mated with each other,
wherein the first connector is provided with a contraction part configured to contract by coming into contact with the second connector during mating, and
the second connector is provided with a confirmation part configured to enable checking a position of the confirmation part relative to the contraction part.

2. The connector according to claim 1, wherein the contraction part has a bellows shape with a pair of a peak and a valley repeated in a mating direction.

3. The connector according to claim 1, wherein the contraction part is elastically deformable in a mating direction.

4. The connector according to claim 3, wherein the contraction part has a perfect circular ring shape as viewed from a second connector side.

5. The connector according to claim 3, wherein the contraction part is provided on a rubber member that covers an outer peripheral surface of a housing of the first connector.

6. The connector according to claim 5,
wherein the housing has a lock arm configured to lock to the second connector, and
the rubber member is shaped to entirely cover the outer peripheral surface of the housing and has a mark at a position corresponding to the lock arm.

7. The connector according to claim 5, wherein the contraction part is in liquid-tight contact with the second connector while contracted in a mated state.

8. The connector according to claim 1,
wherein the second connector has a wall surface that widens in a direction intersecting the mating direction and faces a side where the first connector is located,
the confirmation part has a tubular shape protruding from the wall surface, and
the contraction part is arranged inside the confirmation part in contact with the wall surface in the mated state.

9. The connector according to claim 8, wherein a length of the confirmation part in the mating direction is set to be shorter than a length of the contraction part in the mating direction in a natural state of the contraction part in which no external force is received, and is set to be longer than or equal to the length of the contraction part in the mating direction in a contracted state of the contraction part in contact with the wall surface in the mated state.
